(19) United States
(12) Patent Application Publication
(10) Pub. No.: US 2019/0019376 A1
(43) Pub. Date: Jan. 17, 2019

(54) GAMING METHODS AND SYSTEMS

(71) Applicant: VERSACI INTERACTIVE GAMING, INC., Las Vegas, NV (US)

(72) Inventors: Joseph VERSACI, Las Vegas, NV (US); Marc BOUDREAU, Fonthill (CA)

(21) Appl. No.: 15/988,263

(22) Filed: May 24, 2018

Related U.S. Application Data
(60) Provisional application No. 62/531,005, filed on Jul. 11, 2017.

(51) Int. Cl. G07F 17/32

(52) U.S. Cl. CPC G07F 17/3255; G07F 17/3276; G07F 17/3223; G07F 17/323

(57) ABSTRACT

A platform comprises a system employing an integration layer between the operating system and Direct x or Metal, visual recognition & machine learning techniques and a transactional ad server creating an encrypted json token for Quest registrations. The selected game can be on any one of different or many platforms. The result can have a leveling effect for differently skilled gamers. In a video game, the machine learning trains the system to read one or more game screens of a video game in near real time, and analyzes the screens for game results. A routine permits integration into a program of a video game, without input from a player of the video game.

### RELATED APPLICATION

This application claims priority to U.S. Provisional Application No. 62/531,005, filed Jul. 11, 2017, the contents of which are hereby incorporated by reference in its entirety.

### BACKGROUND

The present disclosure relates generally to videogames and gaming environments, and more specifically, but not by way of limitation, to videogames and gaming environments for participant players on their own or between competitive player participants.

In the video gaming field, streams of data are exchanged between a main server and players of the game. The players input commands, typically through a controlling device, that are effectuated by the characters involved in the video stream. According to the participant's action, the game progresses. As the game progresses, various elements change, include a score, a character location, and various other visually perceptible elements. Generally, these individual elements are stored on the server providing the video data stream, for instance for a game, and rarely is the information saved for an extended period of time or put to any use.

Additionally, there exists a market in which people compete on the competition result. Many may wish to test their skill through ancillary competitions that can occur in concert with their game play. However, at this time, there is no service that will allow for such competition, as there is platform to facilitate these challenges and no universal method of recording the necessary data to allow for verifiable, secure results.

### SUMMARY

Image processing devices allow for the extraction of information from video content in a number of fields, in particular in the field of gaming. Image processors are used in a variety of fields in order to recognize objects according to groupings of common pixels. Once objects are determined, the objects are compared to known objects in order to determine the object type or difference between object types.

There is a need for systems, methods, and apparatuses in videogames and gaming environments, between participants on different platform to be a self-sustaining competitive ecosystem that increases competition and may generate many endless rewards for gamers with zero risk. The disclosed platform can be automatically integrated into a game.

The disclosure is described in further detail below including a concept summary, which sets out a detailed overview of the PlayVIG platform. There is also disclosed a PlayVIG layer in between an Operating System and Direct x for PC and Operation System and Metal for Apple, and a DLL—Dynamic-link library. The disclosure includes a transactional server schematic, encrypted json token for confirmed entry into Quest post and view techniques for Visual Recognition, Template Matching, and Machine learning.

### BRIEF DESCRIPTION OF THE DRAWINGS

Objects and features of the presently-disclosed systems, methods, and apparatuses for extracting and analyzing live video content will become apparent to those of ordinary skill in the art when descriptions of various embodiments thereof are read with reference to the accompanying drawings, of which:

FIG. 1 illustrates a Quest flow.

FIG. 2 illustrates the Quest flow—Stage Start.

FIG. 3 illustrates the Quest Flow Game Started.

FIG. 4 illustrates the Quest Flow Game Image Capturing.

FIG. 5 illustrates a block diagram of the operation of the transaction server.

### DETAILED DESCRIPTION

Embodiments of the presently-disclosed systems, methods, and apparatuses for extracting and analyzing images, in particular in the field of gaming. with reference to the accompanying drawings are described. Like reference numerals may refer to similar or identical elements throughout the description of the figures.

This description may use the phrases “in an embodiment,” “in embodiments,” “in some embodiments,” or “in other embodiments,” which may each refer to one or more of the same or different embodiments in accordance with the present disclosure.

Terms have been used herein merely for purposes of convenience and such usage should be interpreted broadly as would be apparent to a person of ordinary skill in the art. For example, the terms “software” and “code” as used below, should be interpreted as being applicable to software, firmware, or a combination of software and firmware. Similarly, the term “game data” should be interpreted as being applicable to a wide variety of information pertaining to a game, some of which may be captured and stored in hardware, and some of which may be merely visual observations made by a developer or a game player.

A platform comprises a system employing an integration layer between an operating system and an API, selectively Direct x, selectively at least one of visual recognition and machine learning software routines and selectively a transactional ad server creating selectively an encrypted json token for a Quest registration. The integration layer between the operating system and Direct x allows for a Quest to be created that are independent to the actual win/loss of the game.

A platform comprises a system employing an integration layer between the operating system and Direct x, visual recognition & machine learning techniques and a transactional ad server creating an encrypted json token for Quest registrations.

One aspect of the disclosure is a platform including a built in “virtual referee” that uses visual recognition, for example in form employing a frame by frame reading and analyzing as disclosed in the related patent application and described more fully herein. Additionally, there is a machine learning process. This enables us to grade Quests and credit players with a result of successful or failed. The Quest allows gamers to add competition and rewards to their favorite games. The favorite game can be on any one of different or many platforms. A Quest creates a result that can make the game different to a straight win/loss competition, and/or the Quest levels the playing field for less skilled gamers to win.

The machine learning is used to train the system to read game screens in near real time and, and analyze the screens for the “game results.”

There may be no need to integrate the invented platform into the games. Additionally, the system may obviate a need for the user to “self-report” the results of their contests.

The Quest may provide for almost or essentially relatively instant competition.

The disclosed platform allows users to win real rewards with no or minimal risk or consideration on their part. Prior to each contest our users opt in to watch a short video advertisement. The revenue from these advertisements creates a prize pool that the gamers will win in the form of successful Quests.

The disclosed platform provides for a self-sustaining competitive ecosystem that increases competition and may generate many endless rewards for gamers with little or essentially zero risk.

The disclosed platform can be automatically integrated into a game without requiring user input.

The system, method and process of the disclosure involves leveraging computer vision and machine techniques in order to interpret and extract real timegame play session information in electronic video games. One or more of computer vision techniques can be applied separately or collectively to affect this interpretation and extraction. Extracted information includes, but is not limited to, player's statistics (points, teams, weapons, milestones), session results (win, loss, tie), and session meta data (time, difficulty). Information is then used for a variety of purposes such as stats aggregation and use in supporting competitions (tournaments, skilled based events, leaderboards, etc) for the respective electronic video game.

The platform, system and methods may comprise: (a) establishing a referee role within a gaming environment, between a plurality of participants. The present technology may be directed to methods for providing referee involvement within a gaming environment. These gaming systems may comprise: (a) a memory for storing executable instructions; and (b) a processor for executing the executable instructions, the executable instructions comprising: (i) a roll generator module that establishes a referee role that allows referee control of game play relative to a competition, within the gaming environment, between a plurality of participants.

In one exemplary method for analyzing the performance of a video game using non-intrusive capture and storage of game data, a capture format is used for capturing game data. The game data includes parameters associated with execution of an application code as well as run-time parameters/measurements associated with hardware of a game platform upon which the application code is being executed. The captured data is stored in a storage medium.

The following description generally provides details of systems and methods for analyzing the performance of a video game by non-intrusively capturing and storing run-time game data during execution of gaming application code. Run-time game data can include any combination of audio data, video data, GPU data, CPU data, or the like. The non-intrusive nature of the data capture permits operation of the video game without extrinsically contributing to the problem or significantly affecting game performance.

The disclosure is further directed to an application and/or platform identified by way of example as “PlayVIG”. (VIG and PlayVIG are trademarks of the Applicants).

PlayVIG can be a free to use application that offers gamers of different or all skill levels and genres the ability to add value and competition to their favorite games. PlayVIG can use an easy to use Heads Up Display which allows gamers to take on the house in single player Quests or join other gamers in multi-player tournaments. Contests can use single click access, instant result grading and real prizes. PlayVIG can make competitive gaming relatively simple.

PlayVIG comprises a platform, which brings advertisers and gamers together by giving gamers an extra competitive experience through single player quests and multi-player tournaments with the ability to compete for coins which are funded by premium Ad views to then purchase goods from the VIG store.

PlayVIG Virtual Referee

PlayVIG includes a Virtual Referee. The Virtual Referee technology monitors game play and renders almost in real time or near time or immediate results without game integration or user input. PlayVIG includes techniques in the fields of Visual Recognition, template matching and machine learning to replace the technical integration and user burden of traditional gaming competitions.

The disclosure can combine one or more or a wide variety of open source techniques to train the Virtual Referees on a particular game. In addition to the skill of visual recognition and machine learning, PlayVIG identifies and monitors the game play of players. This happens through game client integrating at a low level of the games process.

The disclosure can extract frames from the game, crop and compress them before sending them to one or more recognition servers to be processed. The result of this image processing is then sent back to the game client as well as through to a core gaming platform where the logic of whether or not a user has completed the request achievements has been accomplished. If so, our Virtual Referee may in time which can be near instant time grade the contest and award a reward which can be coins. If there is a non-complete, the message can be transmitted that user has lost.

In either case the recognition server, local game client and core gaming platform can maintain a persistent connection to ensure all images are digested and converted to character based data that can be read and stored by our core gaming platform.

PlayVIG Game Modes (Achievement not Result Based)

PlayVIG technology allows the setting of goals and achievements to create a unique single or multi-player experience. The Quest and Tournament technology and formats leverage the player's natural behavior and game matchmaking to provide a more even playing field and more equal opportunity for all players and users to win.

PlayVIG players and users are not necessarily playing against each other, but rather playing their favorite games as they normally would. The Virtual Referee monitors their play and ranks their achievements against internal benchmarks (lp Quests) or other users (Tournaments) and awards rewards such as coins based on how efficiency they accomplish the series of tasks associated with their Quest or Tournament.

PlayVIG Ad Monetization and Store

PlayVIG uses the natural breaks in games, such waiting for the game to find an opponent or load the users game prior to playing, to allow players to opt into ads. The revenue generated from these ad views combine to form the prize pool for which the players are competing for. Players can then use the coins they have won to make purchases in a PlayVIG online store or other affiliated store. Players can purchase a wide variety of virtual and physical goods selectively aimed at further improving their in-game experience by acquiring new popular games, downloadable content or gaming related gear.

The process and components are further described below.

PlayVIG User Flow:
1. Download and install our Client
2. Register for an account
3. Choose the game the player wants to play
4. Choose to play in a 1 player Quest (i.e. win 3 in a row) or a multiplayer Tournament (i.e. post the fastest time to score 50 goals).
5. Launch the selected game as normal
6. Matchmaking as it is a natural break in the game thus is when gamers and players typically watch the full screen premium Ad to ‘register’ for the Quest or Tournament
7. Play the selected game to progress towards your Quest or Tournament goal
8. Upon success, get awarded coins
9. Go to the PlayVIG store to redeem the won coins for prizes; such as, in-game items, gift cards, etc.

PlayVIG System Components:
Client Applications—these are, for lack of a better term, “dumb” slave clients which are the main interface for the end users. They themselves have very little logic and take their direction from the Core system and the Referee servers.
Core Platform—Your typical ‘core platform’ feature wise in that this is where your transactional data; such as, users, quests, tournaments, wallets, etc. all are handled. For example, when a user completes or wins a quest, it is this part of the system, which tells the Client “Victory with 200 coins”, and the Client shows it and changes state to allow the user to proceed. The PlayVIG platform is a real-time system so the communication between the core platform and the clients is through a persistent socket connection—whenever anything of interest happens for the user, the Client will be notified and updated.
Referee Servers—These are what handles the Computer Vision and Machine Learning logic. The Client applications establish persistent socket connections to a Referee and the Referee then uses screenshots from the clients to drive workflows representing the game session and extract data from the session (i.e. number of goals, total health, etc.).
Ad Network—A third party Ad Network is leveraged to serve up the advertisements to the end users.
Transaction Server—The Transaction Server tracks the ad views and buy-ins. Essentially, the client must communicate between the Core, the Ad Network, and the Transaction Server to show and ad, verify it is complete, and credit the user their registration in the contest.
Store—A web experience wherein users redeem their coins for prizes.

Overview

The PlayVIG client allows a player to play Single & Multiplayer quests. These quests follow the following flow:
1. Select Game
2. Select Quest for selected Game
3. Watch Video
4. Capture & Transmit Screenshots from selected Game to Virtual Referee Server
   a. Until final state is detected by Virtual Referee Server
5. Display State (i.e. Win, Lose, Next Stage, etc.)

Components

The client uses the following components to complete the quest:
1. Core Platform Server—Manages the Game System
2. VR Server—Manages the Image Recognition
3. VRBrowser—Used for Browser Windows (Video/History)
4. VRBridge—Used to bridge communication from C++/C#
5. VRDx—32-bit DirectX 9 & DirectX 11 Hook
6. VRDx64—64-bit DirectX 9 & DirectX 11 Hook
7. VRInject—32-bit Process Injector
8. VRInject64—64-bit Process Injector

Quest Flow—Overview

A Quest can be considered as a competition state or level that is created based upon “skilled based actions within the game”.

By way of example, a particular game is examined for skill based elements. A competition state or level is developed and set around the game by defining the state or level requirements for the gamer to achieve in order to win. A Quest is the product name given to a competition state or level.

The results of a Quest is are not directly correlated to winning or losing the competition within the actual video game i.e. a player can achieve a Quest and win on the disclosed system but lose within the actual game being playing.

Quests vary on a game by game basis based on the skill elements that are unique in each game.

i.e. in the NBA videogame making 3-point baskets is a skill. We can have a Quest that is making five 3-point baskets in the first quarter. If the player does that, they win a Quest.

The disclosure can also combine skill elements to make a Quest more difficult i.e. in the NBA videogame, the disclosure can define a Quest so that it is “make five 3-point baskets in the first quarter and get 10 rebounds and 5 assists in the game”. In this example the player would need to accomplish all 3 skills to win the Quest.

More specifically, and in one form, a Quest can be defined to be as follows:

It can be a Mission or competition state or level of a game. It can also include at least one of a:

1. Name

2. Comment

3. Mission

a. Single Player
i. Wins—Win 1, 2, 3, . . . n games, they do not have to be sequential
ii. Streak—Win 1, 2, 3, . . . n games, they must be sequential
iii. Skills—You must complete a specific list of criteria. The criteria will vary based on the game.

b. Multiplayer
i. Race—You are timed based on how long it took you to complete a specific list of criteria. The criteria will vary based on the game.
ii. Time Trial—You have a certain amount of time to complete a specific list of criteria. The criteria will vary based on the game.

4. Payout

a. Single Player
i. Fixed payout on completion of Mission

b. Multiplayer
i. Payout table with percentage payout for top finishers.

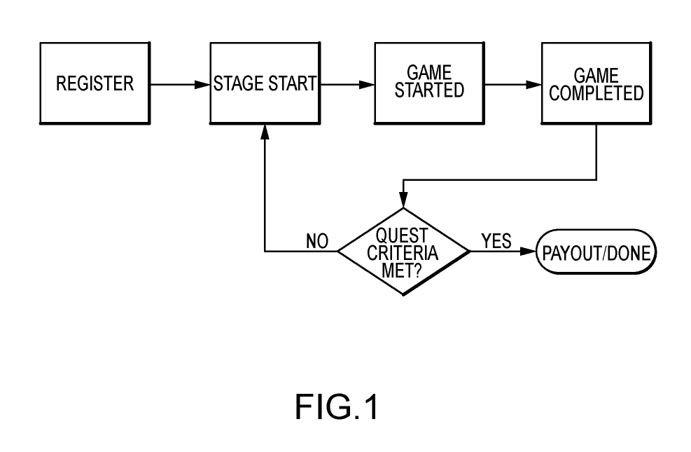

The quest flow which is illustrated in FIG. 1 is as follows:

Quest Flow—Register

On the Quest Selection dialog, the user will be presented with a list of either single or multiplayer quests. The user will select a quest from this list. If they are not registered in the selected quest, they will be registered via a call to the Core Platform Server. Otherwise, their quest state will be reverted to the registration state.

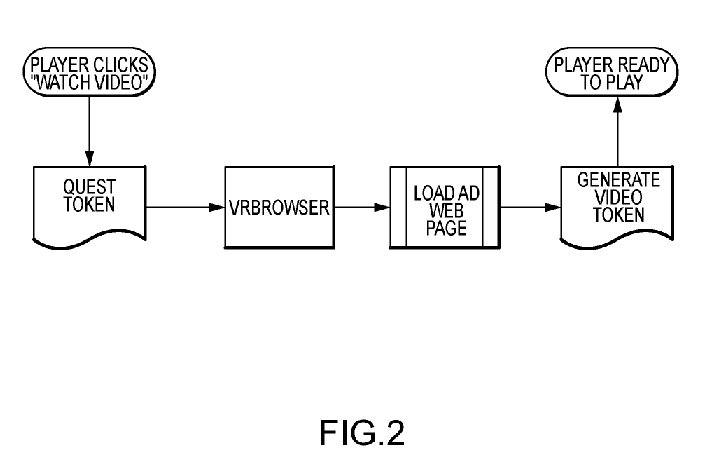

Quest Flow—Stage Start Illustrated in FIG. 2 is as Follows

The user will be presented with a button to “Watch Video”. Once the button is pressed, the client will request an Ad Token from the Core Platform Server. The Ad Token will be passed to the VRBrowser component. The VRBrowser will pass the token to Ad web page. The Ad Web page will validate the token and play the video. When the video playback ends, it will generate a new token and callback the VRBrowser with it. The VRBrowser will pass this token back the client. The client will send the new token generated by the VRBrowser, to the Core Platform Server. This will transition the quest to next state.

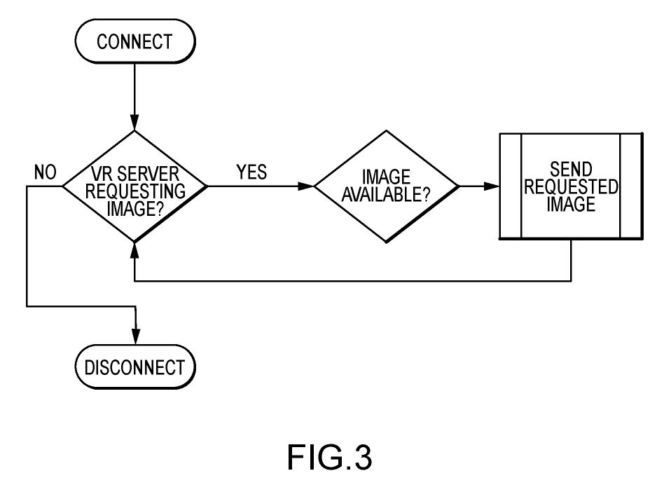

The Quest Flow Game Started which is illustrated in FIG. 3 is as follows:

The client will create a connection to the VR Server. It will send the follow information on connection:
1. Core Platform User Session Token
2. Quest Identifier
3. User Identifier
4. OS Type
5. Game Type
6. Game Version

The VR Server will respond with the next requested image identifier and image capture interval. The client will begin capturing images from the game at the specified interval. The images will be identified by the interval. (i.e. Image0 is at time 0, Image1 is at time interval 1, Image2 is at time interval 2, etc.) Once the requested image is available, it will be sent to the VR Server. The VR Server will respond with either a request of a new image or not. If an image is requested, we wait for the image and continue the cycle. Otherwise, we close the connection to the VR Server.

Quest Flow—Game Completed

The client will receive a notification from the Core platform server, on the outcome of the game session. The user will be notified on the outcome of the game session. If the quest is not completed the user will be automatically put back to a “Stage Start” phase. Otherwise, the user will be paid out for single player quests and for multiplayer quests paid if they were in the top paid positions.

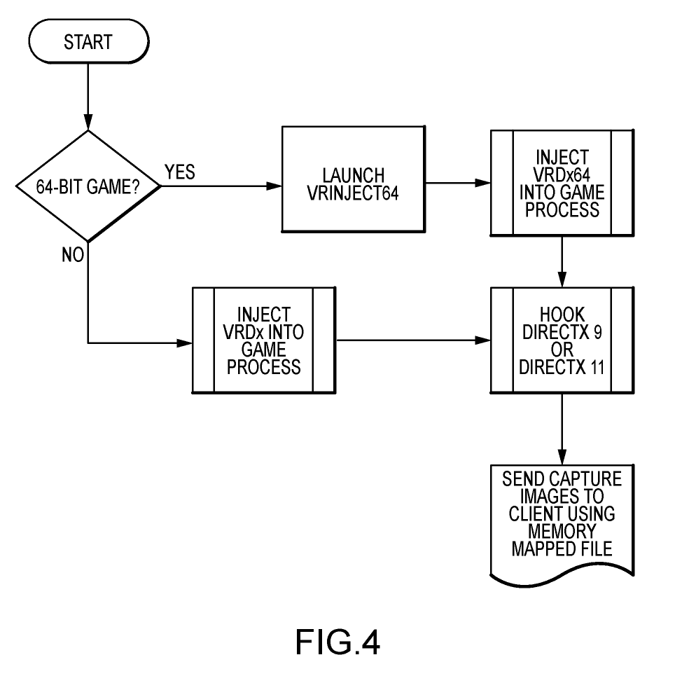

The Quest Flow Game Image Capturing which is illustrated in FIG. 4 is as follows:

Before images can be captured, we must first hook the DirectX 9 or 11 D11 (i.e. d3d9.dll or d3d11.dll). Assuming the client is a 32-bit application, it will use VRInject64 to hook a 64-bit game. Alternatively, if the client were a 64-bit application, it would use VRInject to hook a 32-bit game. In either case, we use Windows Hooks to hook into the game's process. Once, we are inside the game's process, we can now intercept the DirectX calls from the game. We will intercept the appropriate DirectX Rendering calls, depending on the DirectX Version. On the render calls, we will use a memory mapped file to send the current image in the DirectX video buffer.

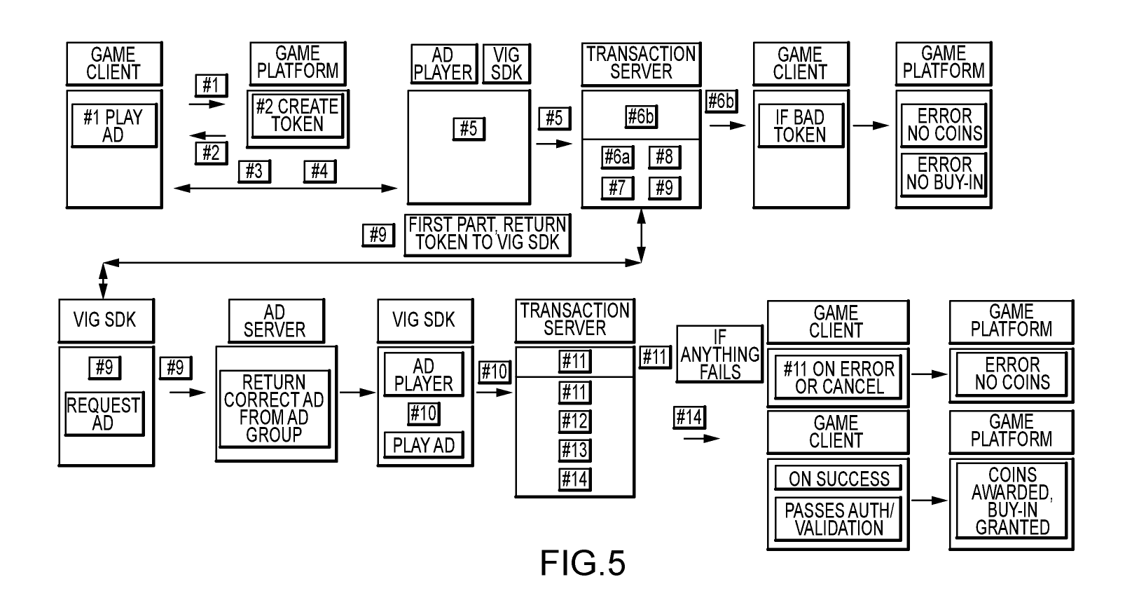

The Transaction Server which is illustrated in FIG. 5 includes as an example different components.

Hosting/Servers

The transaction server currently uses three separate virtual servers. One for the application server, one for the database server and one for the front facing reverse proxy server.

Each server has the following specs.
Memory==2gb
Intel Xeon CPU E5-2430 v2 @ 2.50 ghz
64-bit
2 cores
L1d cache==32K
L1i cache==32K
L2 cache==256
KL3 cache==15360K

Application

The application server is where the transaction server logic runs. Built in Python using Django Framework. The application runs inside a virtual environment served by Gunicorn.
Ubuntu==16.04.2 LTS
Virtualenv==15.1.0

1. Django=1.11.1

2. Gunicorn==19.7.1

3. PyJWT==1.5.0

4. psycopg2==2.7.1

Database
Ubuntu==16.04.2 LTS
Postgresql==9.5.7

Reverse Proxy
Ubuntu==16.04.2 LTS
Nginx==1.10.0

Outline

The purpose of the transaction server is to help prevent any possible gaming of the system by way of manipulation of the number of ads viewed, spammed or automated. The game platform needs a way to verify if the player has actually watched an ad himself and in its entirety before awarding him credit/entry for watching the ad. since ad servers do not protect or verify the communications between the ad/ad player and the ad server pertaining to when the ad player is sending ad watched duration/completion we cannot rely on them for player watched verification (as normally there would be no reason for a user to exploit this).

How it Works

The transaction server sits in between the video being watched and where the player is getting awarded credit (client/game platform) and where the ad is coming from (the ad server). The machine in the middle (transaction server) and the game platform speak to one another using a token implementation JWT (json token that is signed and uses a shared secret key) to make sure that the player is actually watching the ad all the way through and not just running scripts to automate the process or canceling the ads and still being credited. The transaction server also records several different data fields that can be used for further checking of users trying to game the system. Those fields are the unique user/gamer ID, page ID (tells what ad group the ad came from), publisher token (has information about the quest/tournament), when the ad started being watched and when the ad was done being watched, the status of the ad (initiated, completed, canceled or error) and finally the cpm (amount of coins put into the system from the ad view).

Technical Flow
1. Player presses watch ad button to watch ad for entry.
2. Game platform generates JWT token for said player.
3. Game client renders ad player & VIG SDK.
4. Game client initiates the VIG SDK & passes player token, on success callback & on error callback into the SDK.
5. The SDK send token to the transaction server to be processed.
6. The transaction server checks the token for authenticity (that it came from the game platform), makes sure the token hasn't expired (time based) & retrieves information from the database about the ad group being requested by the game platform.
7. a—If the token is valid the transaction server records the new transaction to the database with an initiated state, and the current time stamp, user ID, ad group ID, cost and the ad group ad duration (for later checking if the complete request is at least >=then said duration).
   b—If the token is NOT valid the transaction server returns an error with message if possible of the reason that the token failed.
8. The transaction server creates a new token with original information from first token sent by the platform and the newly retrieved ad group information and the newly created uuid₄ ID for the transaction for later access.
9. The transaction server returns the token created in step 9 to the VIG SDK. Once the VIG SDK receives this valid token response it requests an ad from the ad server with the desired ad group ID that is in the token.
10. The ad player then plays the ad for the player to watch. Once the ad has been either completed, canceled or an error has happened, the VIG SDK sends the token to the transaction server.
11. The transactions server checks the token for authenticity and uses the same method of checking as in step 6. If the token was received as an ad completed token the current time stamp is checked against the transaction initiated time stamp to make sure enough time (minimum ad duration for ad group requested) has expended. The transaction server also checks the state of the current transaction making sure that it hasn't already been set to anything other than initiated as that would imply that someone is trying to use an already completed transaction.
12. The transaction server then updates the transaction record in the database to reflect the new transaction state to completed, canceled or error and the current time stamp of ad completion.
13. The transaction server creates a new token with the updated information, player/user ID, the game platform token (different token entirely and is only passed back to the platform to identify what quest or tournament the transaction pertains to) and also how many coins to ad to the game platform/system.
14. This token created in the previous step (13) is returned to the Vig SDK and from there it is passed into the on success callback back to the game client and game platform to be processed.

Exemplary architecture for practicing the disclosure includes a networked gaming system implemented within the context of a plurality of web servers. An end user computing system may be communicatively coupled to the server via a network connection which can be a private or public network such as the Internet. End user computing systems may comprise, for example, a personal computer or a gaming console. A referee may oversee and/or control game play within the gaming environment generated by a videogame using their end user computing system.

The networked gaming system may be a particular purpose computing environment that includes executable instructions stored in memory. These instructions, when executed by the processor provide referee features within the gaming environment. The networked gaming system may execute the videogame program to generate a gaming environment and there are routines for facilitating referee interaction with the gaming environment. The videogame program can be a multiplayer networked videogame such as a sporting event, a MMORPG (massively multiplayer online role-playing game), a first-person shooter, a strategy game, role playing games, action games, arcade games, and simulation games.

The computing system includes one or more processors and memory stores, in part, instructions and data for execution by the one or more processors. Memory can store the executable code when the computing system is in operation. The computing system may further include a mass storage device, portable storage medium drive(s), output devices, user input devices, a graphics display, and other peripheral devices.

The computing system includes a computing device, a processing unit, a system memory, and a system bus that couples various system components including the system memory to the processing unit. The system bus may be any of several types of bus structures including a memory bus or memory controller, a peripheral bus, and a local bus using any of a variety of bus architectures. The system memory includes read only memory (ROM) and random access memory (RAM). A basic input/output system containing basic routines that help to transfer information between elements within the computing device, such as during start up, is stored in ROM. The computing device may include a hard disk drive for reading from and writing to a hard disk, a magnetic disk drive for reading from or writing to a removable magnetic disk, and an optical disk drive, a CD ROM or other optical media. Input devices may include a microphone, joystick, game pad, satellite disk, scanner, or the like.

The various techniques described can be implemented in connection with hardware or software or, where appropriate, with a combination of both. The program(s) can be implemented in assembly or machine language, if desired. In any case, the language can be a compiled or interpreted language, and combined with hardware implementations. The methods and apparatuses for implementing non-intrusive capture and storage of run-time game data and/or analysis of the performance of a video game also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device, a client computer, or the like.

Although embodiments have been described in detail with reference to the accompanying drawings for the purpose of illustration and description, it is to be understood that the inventive processes and apparatus are not to be construed as limited thereby. It will be apparent to those of ordinary skill in the art that various modifications to the foregoing embodiments may be made without departing from the scope of the disclosure.

1. A platform comprises a system employing an integration layer between an operating system and an API, selectively Direct x or Metal, selectively at least one of visual recognition and machine learning software routines and selectively a transactional ad server creating selectively an encrypted json token for reaching a game competition state or level, such competition state or level, selectively being considered as a Quest registration.

2. The platform of claim 1 that the integration layer between the operating system and Direct x allows for a Quest to be created that are independent to the actual win/loss of the game.

3. The platform of claim 1 including applying in a video game, the machine learning to train the system to read one or more game screens of a video game in near real time, and analyze the screens for game results and independent instances throughout the game.

4. The platform of claim 1 including a routine permitting integration into a program of a video game without input from a player of the videogame.

5. The platform of claim 1 wherein the platform reports a result or independent achievements of a video game contest.

6. The platform of claim 1 wherein in a video game contest, the platform contains a routine requiring, prior to each contest, a user is compelled to opt in to view a video, selectively, an advertisement video, and a system, wherein the opting in is counted and wherein a revenue factor is applied to the viewing counts, and wherein the revenue factor is applied to create a prize pool that the user is capable of winning, selectively as a reward coin.

7. The platform of claim 1 including an application offering garners of different skill levels and genres the ability to add value and competition, selectively using a Heads Up Display, and wherein selectively there is single click access, result grading and the distribution of the prize pool.

8. The platform of claim 1 including bringing advertisers and garners together, selectively by giving garners an extra competitive experience through single player quests and multi-player tournaments, and selectively including the ability to compete for prizes, token coins, selectively funded by advertisement views to then selectively to permit purchase of goods from a store.

9. The platform of claim 1 including a virtual referee for monitoring game play and rendering almost in real time or near time or immediate results without game integration or user input.

10. The platform of claim 1 including using at least one technique in the fields of Visual Recognition, template matching and machine learning.

11. The platform of claim 1 including combining one or more or a wide variety of open source techniques to train a Virtual Referees on a game, selectively through game client integrating at a low level of the game process.

12. The platform of claim 1 including extracting frames from the game, cropping and compressing images before sending them to one or more recognition servers to be processed.

13. The platform of claim 1 including having a recognition server, local game client and core gaming platform maintain a persistent connection to ensure images are digested and converted to character based data that can be read and stored by our core gaming platform.

14. The platform of claim 1 including using natural breaks in games to allow players to opt into ads, and selectively applying revenue generated from ad views to form the prize pool for the players, and selectively having players use winnings to make purchases in an online store.

15. The platform of claim 1 including the system components of Client Applications, a Core Platform for transactional data; such as, users, quests, tournaments, wallets, Referee Servers for handling Computer Vision and Machine Learning logic. an Ad Network to serve up the advertisements to end users, a transaction server tracking ad views and buy-ins and to show an ad, verify it is complete, and credit the user their registration in the contest, and a Store wherein users redeem their coins for prizes.

16. The platform of claim 1 including within a gaming environment, establishing a referee between a plurality of participants, the referee being established using a networked gaming system running on a server.

17. The platform of claim 1 including analyzing performance of a vide game, comprising capturing, using a format, game data responsive to hardware of a game platform, wherein the game data comprises run-time parameters associated with execution of application code of the video game and parameters associated with the hardware of the game platform upon which the application code of the video game is being executed; storing the parameters associated with the hardware of the gaming platform using a storage format, wherein the hardware of the game platform is a graphics processor unit; response to a request to review performance of the hardware of the game platform, relating parameters associated with the hardware of the game platform in accordance with the capture sequence; and analyzing performance data.

18. The platform of claim 1 including hardware of a game platform located on at least one of a central processing unit or a data buffer, and selectively wherein the hardware of the game platform comprises a central processing unit (CPU) coupled to the graphics processor unit (GPU), and wherein the coupling is configured to permit operation of the CPU and the GPU.

19. The platform of claim 18 including wherein the hardware of the game platform comprises a central processing unit (CPU) coupled to the graphics processor unit (GPU), wherein the coupling is configured to permit asynchronous, parallel operation of the CPU and the GPU, and wherein the performance monitor is further configured to display parameters of the CPU relative to the GPU.

20. The platform of claim 1 including having a computer-readable storage medium that is not a transitory signal, the computer-readable storage medium having stored thereon computer-readable instructions for performing the steps of: capturing, using a frame format, game data responsive to hardware of a game platform, wherein the game data comprises parameters associated with execution of application code of a video game and parameters associated with the hardware of the game platform upon which the application code of the video game is being executed; storing the parameters associated with the hardware of the game platform, wherein the hardware of the game platform is a graphics processor unit; responsive to a request to review performance of the hardware of the game platform, analyzing parameters associated with the hardware of the game platform; and displaying performance data, based on the game data captured.
